(19) United States
(12) Patent Application Publication
(10) Pub. No.: US 2002/0007703 A1
(43) Pub. Date: Jan. 24, 2002

(54) System for fastening elements to be connected

(76) Inventor: Santiago Michel Gelos, Zaragoza (ES)

Correspondence Address: KLAUBER & JACKSON, 411 HACKENSACK AVENUE, HACKENSACK, NJ, 07601

(21) Appl. No.: 09/906,891

(22) Filed: Jul. 17, 2001

(30) Foreign Application Priority Data
Jul. 19, 2000 (ES) P200001794

(51) Int. Cl. B25B 7/04

(52) U.S. Cl. 81/385

(57) ABSTRACT

System for fastening elements to be connected, which is useful mainly in carpentry and cabinetmaking, as well as in metallurgy, making it possible to fasten those elements that connect to each other while the connection is consolidated. The system for fastening elements to be connected comprises pliers (1) and some fastening forks (18) whose arms have a loop (20), the arms (2) and (3) of the pliers (1) having a positionable rotation shaft (8), since both arms have a lug (4) and (6), respectively, positioned in the center part thereof, lugs which overlap. A hole (5) and (7), respectively, is defined in each lug (4) and (6) and the shaft (8) passes through the hole and is positionable therein. The hole (5) has a toothed contour.

### OBJECT OF THE INVENTION

As expressed in the title of the present specification, the following invention refers to a system for fastening elements to be connected, which is useful in different industries, since it permits the fastening of elements to be connected during the consolidation of the connection made by different means, of different materials and although the elements are positioned in different ways.

Hence, the system that is presented permits a simple and rapid fastening of elements to be connected not only when they overlap or attach parallelly, but also when the elements form an angle.

The system comprises pliers for the actuation of the fastening elements of the pieces to be connected in the assembly and disassembly thereof, elements that are defined by some pressure forks, in such a way that the pair of arms of the pliers, connected rotatably by means of a movable shaft, permits the elements to be positioned in different relative positions for the purpose of being able to actuate forks of very different sizes and lengths. The forks are defined by a pair of arms that define a loop between them and they are tightened towards the inside at their ends.

In this way, with a minimum effort the pliers permit the opening of the arms of the fastening fork to be used in order to place the fork appropriately in order to fasten the elements to be connected, while the connection is consolidated, placing the necessary number of forks and disassembling them by means of the pliers, when the connection has been consolidated.

### FIELD OF APPLICATION

The system for fastening elements to be connected that is described in the present specification can be applied in any type of industry wherein elements are connected to each other, and the system is especially applicable in carpentry and cabinetmaking, as well as in metallurgy wherein numerous pieces are welded, because the system permits the fastening of wood or metal elements to be connected, when the elements are superposed or overlapped, as well as when an angle is formed between them, that is to say, they are bevel connected.

### BACKGROUND OF THE INVENTION

Like in all industries, in woodworking there has been a great improvement of the tools that craftsmen currently use. There are different machines that facilitate the harder work to be done, although the way that craftsmen work wood has not undergone any significant changes.

Hence, among the different tools that are used in carpentry and cabinetmaking, we can cite the so-called “jacks” that are used to fasten different elements to be connected to each other, and which are formed by a generally L-shaped metal body along whose larger wing a body whose free end has a threaded hole in which there is a clamping screw, is slidable. This faces the free end of the smaller wing of the generally L-shaped body.

Said clamping screw has an actuating head and a block, generally of rubber, at its opposite end, which presses on the elements to be connected in order to prevent possible wear, since the elements rest on the free end of the smaller wing and said clamping screw.

In this way, since the body slides along the larger wing of the L-shaped base body, it adapts to very different thicknesses and lengths, but it has the inconvenience that it is quite heavy and difficult to handle for just one person in the fastening operations. Furthermore, when bevel-connected bodies are to be fastened, the assembly process is very complex.

Hence, if for example the sides of a drawer that are bevel-connected at a 45° should be connected, four jacks should be used in order to hold same perfectly and said operation should be carried out by two people in order to make sure that the sides to be connected do not move, since the bevel connection makes it easy for them to move.

In this way, the four jacks will be placed along the four sides so that the fastening can take place, and hence a lot of time is used in said fastening and the assembly obtained, the drawer to be formed with the four fastening jacks, is not very manageable due to the heavy weight thereof and the possibility that any of the jacks may accidentally move.

In short, even in some cases the described jacks are perfectly valid such as when superposed longitudinal beams are to be fastened. In other cases actuation thereof is very complex and a single person cannot actuate same.

Likewise, the owner of the present application is owner of patent of invention no. P9600215 for: “Device for fastening elements to be connected”, which is based on a tool that permits fastening means of elements to be connected to be actuated, in such a way that the tool is defined by two rotatably connected arms, the operator's actuating sides on the tool being aided by a spring that operates by pulling and the fastening means are defined by elbowed pliers, whose arms have some projections fitting in some integral pivots of the distal ends of the operating tool used in the assembly and disassembly of the fastening means.

### DESCRIPTION OF THE INVENTION

The present specification describes a system for fastening elements to be connected, which is preferably useful in carpentry and in cabinetmaking, as well as in metallurgy, making it possible to fasten those elements that are connected to each other. The system for fastening elements to be connected comprises pliers and some fastening forks whose arms form a loop, the arms of the pliers having a positionable rotation shaft since both arms have a lug positioned in the center part thereof, lugs that are overlapped. In both lugs there is a hole through which the rotation shaft of both arms passes and is positionable in. The hole of one lug has a toothed contour, whereas the hole of the other lug defines some rounded recesses open at their center part and the distal ends for the user's actuating of the pliers have some threaded holes, as well as a pair of holes where there is a spring, which is in compression tending to bring the distal ends of the pliers together.

The rotation shaft of the arms of the pliers is defined by a cylindrical-shaped body which at one of its bases has a head and which has axially in the center a threaded recess along its entire length. It is provided for that two of the side surfaces opposite the head of the generally cylindrical-shaped body define teeth. Respective screws connect at the open bases of the generally cylindrical-shaped body and the screw of the end opposite the head is aided by a spring that clamps the cylindrical section of said body.

In the assembly of the shaft of the arms of the pliers in relation to the holes of the overlapped lugs of both arms, the head of the generally cylindrical-shaped body has its toothed surfaces fit in the teeth of the toothed hole of the corresponding lug and the cylindrical section of the shaft is located in the hole of the other lug that defines some rounded recesses and the spring that actuates the screw threaded to the base opposite the base of the head of the generally cylindrical-shaped body abuts against this lug, maintaining the assembly with respect to the rotation shaft of the arms of the pliers in a static position.

The positioning of the rotation shaft of the arms of the pliers will be carried out by pressing on the spring that keeps the shaft assembly in position unlocking the toothed head of the generally cylindrical-shaped body from the teeth of the hole of the lug in which it locks, moving the shaft assembly through the holes of both lugs towards the desired place.

In this way, we obtain pliers that are adaptable to forks of very different sizes, being very versatile in fastening elements to be connected, irrespective of the size and material of the elements. They are applicable in numerous industries.

In order to complement the description that is going to be made hereinafter and in order to provide a better understanding of the characteristics of the invention, the present specification is accompanied by a drawing in whose figures the most characteristic details of the invention are represented in an illustrative and non-restrictive manner.

### BRIEF DESCRIPTION OF THE DRAWINGS

FIG. 1 shows a view of the system for fastening elements to be connected, showing the pliers-type tool, that permits the fastening element to be put in place and disassembled, element defined by a fork. The fork shown in the representation is ready to be actuated by the pliers.

FIG. 2 shows a detailed view of the lug of one of the arms of the pliers that overlaps a lug of the second arm in order to be able to position the rotation shaft between the arms.

FIG. 3 shows a view of the rotation shaft between both arms, showing how it is aided by a spring in order to keep it in the operating position, locking in a recess of one of the lugs and permitting rotation of the other lug.

FIG. 4 shows a head of the rotation shaft of the arms of the pliers, showing the teeth of two of the opposite surfaces thereof for locking same into the corresponding recess of a lug of one of the arms of the pliers.

FIG. 5 shows a view of a fork carrying out the fastening of the sides of a drawer, in a bevel arrangement, permitting the drawer to be anchored, because the free ends face to face of the fork end in a pointed manner.

FIG. 6 shows a view of a fork which fastens by pressure elements to be connected, showing the attachment ends, as well as the recesses where the pliers-type tool actuates and in which respective pivots of the diverging ends of the cited pincers will be positioned.

### DESCRIPTION OF A PREFERRED EMBODIMENT

In view of the commented figures and according to the numbering used, we can see how the system for fastening elements to be connected comprises pliers (1) whose arms (2) and (3) have respective lugs (4) and (6), positioned approximately in the center part thereof, lugs which overlap. In the lug (4) of the arm (2) a hole (5) with a toothed contour is defined, whereas there is a hole (7) in the lug (6) of the arm (3) wherein there are some rounded recesses opened by arches.

Hence, the lugs (4) and (6) of the arms (2) and (3) of the pliers (1) overlap and in relation to the holes (5) and (7) there is a shaft (8) capable of being positioned in different positions, permitting a larger or smaller separation between the arms (2) and (3).

For this purpose the shaft (8) is defined by a cylindrical body (11) provided in relation to one of its bases with a generally rectangular plan head (10) in whose side surfaces there are teeth (12) and the body (11) has a threaded recess (9) in the center axial position, along the entire length thereof.

Respective screws (13) and (14) connect to the body (11) by its two bases by screwing, and in relation to the cylindrical section thereof there is a spring (15) that clamps it and that is pressed between the lug (6) and the head of the screw (13), keeping the shaft (8) assembly in a static position.

In accordance with the shape of the shaft (8), the shaft will be arranged in relation to the holes (5) and (7) of the lugs (4) and (6) of both arms (2) and (3), in such a way that in the operating position the head (10) with two of its side surfaces toothed is in relation to the toothed hole (5) of the lug (4), the teeth of one body and the other fitting perfectly into each other. On the other hand, the cylindrical section of the body (11) is in relation to the hole (7) of the lug (6) of the arm (3), in such a way that when the operator actuates the arms, the cylindrical action will act as a shaft permitting the use of the pliers.

The shaft (8) is perfectly positioned in its operating position given that the spring (15) keeps it in place, since it abuts between the lug (6) and the head of the screw (13) connected by screwing to one of its bases.

FIG. 3 perfectly shows how in the operating position the shaft (8) has the head (10) of the body (11) locked in the hole (5) of the lug (4), by means of the corresponding teeth of both bodies, in such a way that as the operator actuates the shaft, rotation of the lug (6) with respect to the body (11) is permitted and in turn the arm (3) turns, opening the distal ends of the pliers (1).

The distal ends of the pliers (1) have respective aligned holes (17) between which a spring will be placed, a spring that will be in compression, and likewise, in the distal ends of the pliers (1), both branches have some threaded holes (16) wherein it is possible to assemble some pivots projecting level with the arms.

When it is desired to position the rotation shaft (8) between both arms (2) and (3), it will suffice to press, in the direction of arrow a of FIG. 3, in order to overcome the pressure of the spring (15) unlocking the toothed head (10) from the body (11) with respect to the toothed hole (5) of the lug (4) moving the shaft (8) towards the desired position, with respect to the two holes (5) and (7). When the head of the screw (13) is no longer pressed the shaft (8) will lock as the teeth (12) of the head (10) of the body (11) fit in the desired place of the contour of the toothed hole (5).

The fastening elements are defined by some forks (18) whose arms (19) form a loop (20) that tends to close the distal ends of the forks (18) over themselves, the arms (19) of the forks having respective projections (21), the ends of the forks being able to end in different shapes, in accordance with the elements to be connected. Hence, for example, the ends (22) of the forks (18) may end in a pointed manner, or else they may end in some bodies (23) made of rubber or some other similar material.

The forks (18) whose ends end in a pointed manner may be especially applicable for the fastening of wood ends (24) whose connection is a bevel type one.

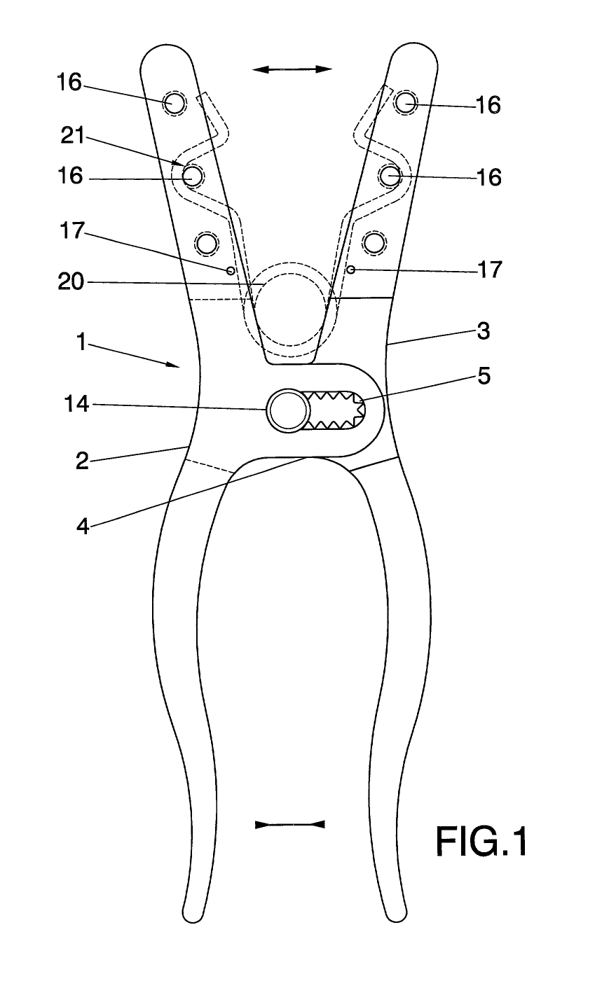

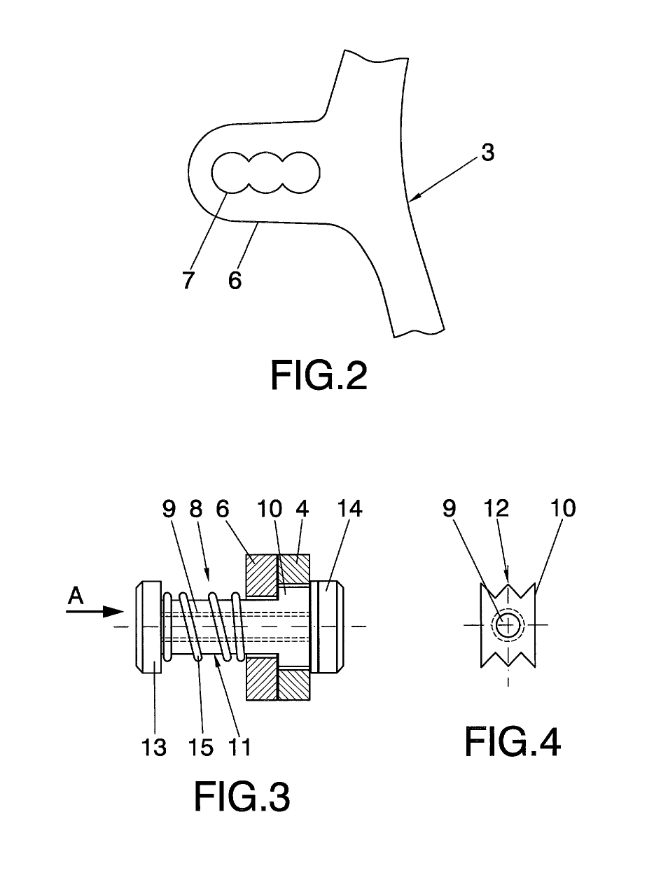

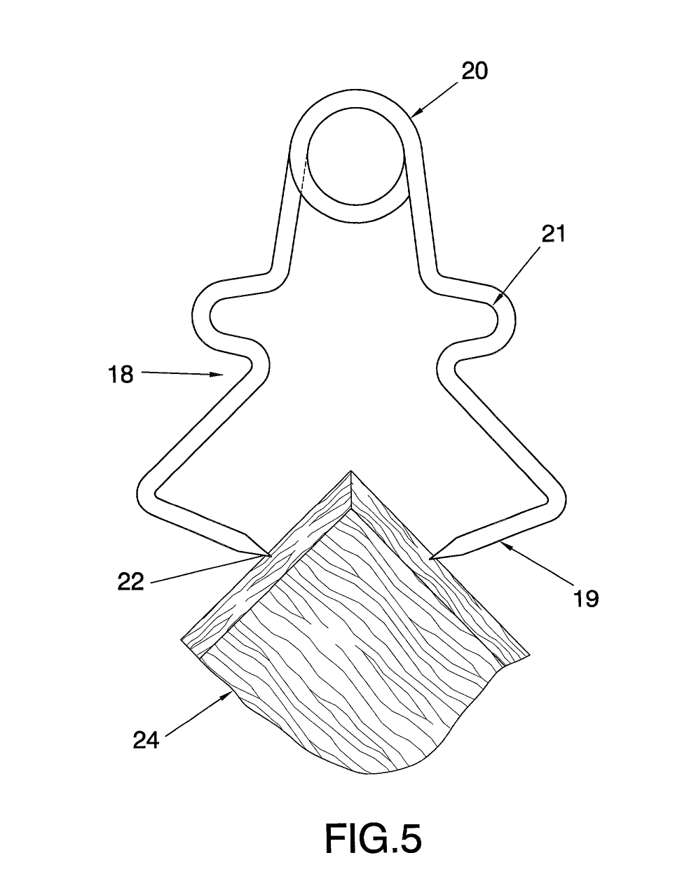

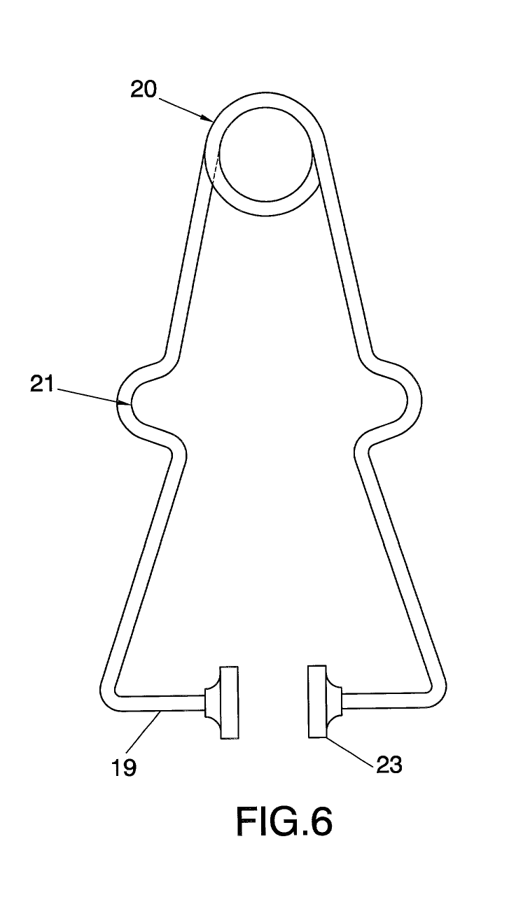

In this way, once the shaft (8) has been placed in the desired position with respect to the holes (5) and (7) the assembly of the desired forks will be carried out for which purpose the corresponding fork will have, as shown by the dash line in FIG. 1 of the drawings, the projections (21) of its two arms (19) with respect to the pivots threaded to the corresponding pair of holes (16) of the distal ends of the pliers, in such a way that when the operator presses the arms of the pliers (1), the distal ends will separate opening the arms of the fork in order to permit placement thereof for the fastening of the desired elements, so that once the connection has been consolidated, disassembly can take place by actuating in the reverse manner.

Hence, the pliers (1) are very versatile as forks of very different sizes can be used, and on the other hand because of the loop defined in the structure of the forks (18).

1. System for fastening elements to be connected, being useful mainly in carpentry and cabinetmaking as well as in metallurgy, permitting the fastening of those elements that are connected to each other while the connection is consolidated, characterized in that the system for the fastening of elements to be connected comprises pliers (1) and some fastening forks (18) whose arms form a loop (20), the arms (2) and (3) of the pliers (1) having a positionable rotation shaft (8), since both arms have a lug (4) and (6), respectively, positioned in the center part thereof, lugs that are overlapped, a hole (5) and (7), respectively, being defined in both lugs (4) and (6), a hole through which the shaft (8) passes and is positionable in, the hole (5) having a toothed contour (5), whereas the hole (7) defines some rounded recesses open in the center part thereof and the distal ends of the pliers, to be actuated by the operator, have some threaded holes (16), as well as a pair of holes through which a spring is assembled.

2. System for fastening elements to be connected according to claim 1, characterized in that the rotation shaft (8) of the arms of the pliers are defined by a generally cylindrical-shaped body (11) that at one of its bases has a head (10) and that has in the center and axially a threaded recess (9) along its entire length, it being provided for that two of the side surfaces opposite the head (10) of the body (11) define teeth (12), respective screws (13) and (14) connecting to the bases of the body (11), the screw (13) of the end opposite the one of the head (10) of the body (11) being aided by a spring (15) that clamps the cylindrical section of said body.

3. System for fastening elements to be connected according to the preceding claims characterized in that in the assembly of the shaft (8) in relation to the holes (5) and (7) of the lugs (4) and (6) the head (10) of the body (11) has its toothed surfaces (12) fit in the teeth of the hole (5) of the lug (4) and the cylindrical section of the body (11) is in respect to the hole (7) of the lug (6) which the spring (15) presses on the screw (13).

4. System for fastening elements to be connected according to the preceding claims, characterized in that the positioning of the shaft (8) will be carried out by pressing on the screw opposite the base of the head (10) of the body (11) pressing the spring (15) and unlocking the head (10) from the teeth of the hole (5), the shaft (8) assembly being able to move through the holes (5) and (7).
